(19) United States
(12) Patent Application Publication
(10) Pub. No.: US 2004/0099492 A1
(43) Pub. Date: May 27, 2004

(54) Brake system for a linear actuator

(76) Inventors: Katsuhiro Onuki, Kanagawa (JP); Susumu Tomioka, Kanagawa (JP); Shigeyuki Hattori, Kanagawa (JP); Kazuo Hokkirigawa, Miyagi (JP)

Correspondence Address: MARSHALL & MELHORN, LLC, PHILLIP S. OBERLIN, 8TH FLOOR, FOUR SEAGATE, TOLEDO, OH, 43604, US

(21) Appl. No.: 10/646,663

(22) Filed: Aug. 21, 2003

(30) Foreign Application Priority Data
Apr. 8, 2002 (JP) 2002-105093

(51) Int. Cl. B60L 7/00

(52) U.S. Cl. 188/163; 188/171

(57) ABSTRACT

In a brake system for a linear actuator comprising: a pair of guide rail members (4), a table (3) including at least a pair of sliders (2a to 2d) which slide along the guide rail members, a linear motor (6 and 7) for actuating the table along the guide rail members, and a brake unit incorporated in one of the sliders, the one slider is provided with a moveable slide block (16) that is supported by the slider (2a) so as to be moveable toward and away from the guide rail surface and a power actuator (8a and 8b, 21 and 30) for selectively moving the slide block toward the guide rail surface. The sliders thus serve the dual purposes of guiding the motion of the table along the guide rail and braking the motion of the table.

### TECHNICAL FIELD

The present invention relates to a brake system for a linear actuator comprising a table, a guide rail and a motor.

### BACKGROUND OF THE INVENTION

Linear actuators are widely used in various fields of industry in such forms as moveable tables of machine tools and conveyers. Such actuators are typically powered by electric motors, and are sometimes provided with a brake system so that the motion of the carriage or table may be controlled even in case of a power outage or other event that would incapacitate the electric motor. Such a brake system typically stops the carriage or table as soon as an abnormal condition is detected, instead of allowing the carriage or table to continue its motion under inertia, and thereby provides a simplified safety feature.

However, conventional brake systems are known to have a number of problems. They are unacceptably heavy and bulky when a high load bearing capability and a high reliable are required. Limited durability is also a problem.

Japanese patent laid open publication JP10-112971A discloses a brake system comprising a brake pad that engages a friction member attached to the guide rail under the biasing force of springs and an electromagnetic device that normally keeps the brake pad spaced away from the friction member when energized. In case of a power outage, the brake pad engages the friction member. When electric power is restored, an air cylinder device moves the brake pad away from the friction member against the biasing force of the spring.

Japanese patent laid open publication JP2000-184686A discloses a similar brake system which is powered by springs, and kept disengaged by an electromagnetic device.

In these brake systems, the brake pads are laterally displaced from the guide rail, and the brake force therefore causes a moment to the table or carriage in such a manner that the brake system tends to be subjected to a complex external force. This requires the brake system to be adequately reinforced, and this adds to an increase in manufacturing cost and complexity of the structure. Also, the brake system tends to be larger than desired. Also, the moment that would act on the brake system causes a variation in the gap between the brake pad and friction member, and this prevents a stable operation of the brake system.

Another problem of these conventional brake system is that there is no arrangement for amplifying the force produced by the electromagnetic device and this results in the need for a relatively powerful electromagnetic device which inevitably is large in size. The need for an air cylinder as is the case with the invention disclosed in JP10-112971A is undesirable for obvious reasons.

### BRIEF SUMMARY OF THE INVENTION

In view of such problems of the prior art, a primary object of the present invention is to provide a brake system for a linear actuator which is capable of a stable braking action even when the brake load is high.

A second object of the present invention is to provide a brake system for a linear actuator which is reliable in use and compact in size.

A third object of the present invention is to provide a brake system for a linear actuator which is simple in structure and economical to manufacture.

According to the present invention, at least most of these objects and other objects can be accomplished by providing a brake system for a linear actuator, comprising: a guide rail; a table including a slider which is guided by the guide rail for a motion along a length of the guide rail, the slider comprising a moveable slide block that is adapted to slide along a surface of the guide rail and is supported by the slider so as to be moveable toward and away from the guide rail surface; a linear motor for actuating the table along the guide rail; and a power actuator for selectively moving the moveable slide block toward the guide rail surface; the moveable slide block sliding over the guide rail surface for a guiding action in a first state of the power actuator and bearing upon the guide rail surface for a braking action in a second state of the power actuator.

The slider thus serves the dual purposes of guiding the motion of the table along the guide rail and braking the motion of the table. In particular, because the brake force is produced in the guide rail, the moment acting on the table as a result of the braking action is minimized so that a stable braking action is ensured even when the brake load is high. This contributes to an improved reliable, compact design, simple structure and low manufacturing cost.

According to a preferred embodiment of the present invention, the guide rail comprises a pair of mutually parallel guide rail members, and the table comprises a pair of late rally arranged sliders in a corresponding manner. Also, each of the guide rail members is provided with an upper surface and a pair of side surfaces each forming an acute angle with respect to the upper surface, and one of the sliders is provided with a bottom surface engaging the upper surface, a fixed slide block engaging one of the side surfaces while the moveable slide block engaging the other of the side surfaces. As for the other of the sliders, it is provided with a bottom surface engaging the upper surface, a pair of fixed slide blocks engaging the corresponding side surfaces of the guide rail.

A brake unit may be provided on each side of the table to achieve a laterally even braking action. However, even when a brake unit is provided only on one side of the table, an even braking action can be achieved. For this to be the case, the sliders may be dimensioned in such a manner that when the power actuator is in the second state, the moveable slide block of the one slider and one of the fixed slide blocks of the other slider which is located in a symmetric position to the moveable slide block bear upon the corresponding side surfaces of the guide rail. For instance, when the moveable slide block is located on an outer side of one of the sliders, the sliders may be dimensioned so that the outer slide block of the other slider and the moveable slide bock bear upon the corresponding side surfaces of the guide rail.

A bearing member may be interposed between the slide block and guide rail surface for a favorable guide action and braking action. The bearing member preferably has a static frictional coefficient in the range of 0.15 to 0.25 with respect to the opposing surface. The bearing member may comprise a porous carbon material prepared by sintering a mixture of plant-base carbon and phenol resin.

### BRIEF DESCRIPTION OF THE DRAWINGS

Now the present invention is described in the following with reference to the appended drawings, in which:

FIG. 1 is a front view of a linear actuator incorporated with a brake system embodying the present invention;

FIG. 2 is a fragmentary side view of the linear actuator shown in FIG. 1;

FIG. 3 is a sectional view taken along III-III of FIG. 2 in the engaged state of the brake system;

FIG. 4a is a sectional view taken along IV-IV of FIG. 2 in the engaged state of the brake system;

FIG. 4b is a sectional view taken along IV-IV of FIG. 2 in the disengaged state of the brake system;

FIG. 5 is a view similar to FIG. 4a showing a second embodiment of the brake system according to the present invention;

FIG. 6 is a front view of a linear actuator incorporated with a third embodiment of the brake system according to the present invention;

FIG. 7 is a fragmentary side view of the linear actuator shown in FIG. 6;

FIG. 8 is a sectional view taken along VIII-VIII of FIG. 7 in the engaged state of the brake system;

FIG. 9a is a sectional view taken along IX-IX of FIG. 7 in the engaged state of the brake system;

FIG. 9b is a sectional view taken along IX-IX of FIG. 7 in the disengaged state of the brake system; and

FIG. 10 is a view similar to FIG. 9a showing a fourth embodiment of the brake system according to the present invention.

### DETAILED DESCRIPTION OF THE PREFERRED EMBODIMENTS

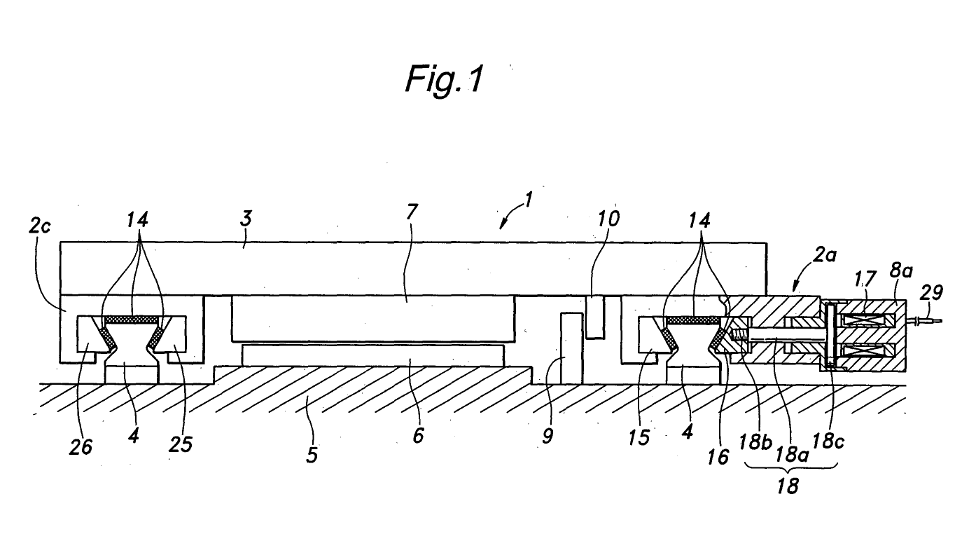

FIGS. 1 to 4 show a brake system embodying the present invention which becomes engaged when power supply is lost. The illustrate linear actuator 1 comprises a guide rail 4 comprising a pair of parallel guide rail members 4 attached to a base 5 and a table 3 supported on the guide rail 4 via four sliders 2a to 2d slidably guided by the guide rail 4, a linear motor including a fixed part 6 attached to the base 5 and a moveable part 7 attached to the bottom surface of the table 3 opposite to the fixed part 6, and a position sensor including a fixed part 9 and a moveable part 10.

FIG. 1 shows two of the four Each guide rail member of the guide rail 4 is provided with a horizontal top surface 11 and a pair of side surfaces 12 which extend obliquely toward each other from a top end adjoining the top surface 11 to a lower end thereof. Therefore, each side surface 12 and top surface 11 jointly define an acute angle when viewed in cross section. In this embodiment, the base of each guide rail member is substantially as broad as the top surface so that the guide rail member defines a pair of V-grooves on either side thereof.

FIG. 1 shows two front ones 2a and 2c of the four sliders 2a to 2d, and the following description will be limited to these because the rear two sliders 2b and 2d have an identical structure as these front ones. Each of the sliders 2a and 2c is fixedly attached to the lower surface of a corresponding corner of the rectangular table 3, and is provided with a rectangular C-shaped cross section having an open end facing downward. A pair of slide blocks 15, 16, 25 and 26 each having a substantially right triangular cross section is received in each of the sliders 2a and 2c in such a manner that the corresponding guide rail member is engaged by the slider substantially without any play. More specifically, the bottom surface of each slider engages the top surface 11 of the corresponding guide rail member via a bearing member 14 which in this case is attached to the slider, and an oblique side of each of the slide blocks 15, 16, 25 and 26 engages the corresponding oblique side surface 12 of the guide rail 4 via similar bearing members 14.

In this embodiment, the slide blocks 25 and 26 for the slider 2c shown on the left side of FIG. 1 are both fixed to the corresponding slider 2c. As for the slider 2a shown on the right side of FIG. 1, one of the slide blocks 15 on the inner side is fixed to the slider while the other slide block 16 on the outer side is retained so as to be moveable in the lateral direction to a certain extent.

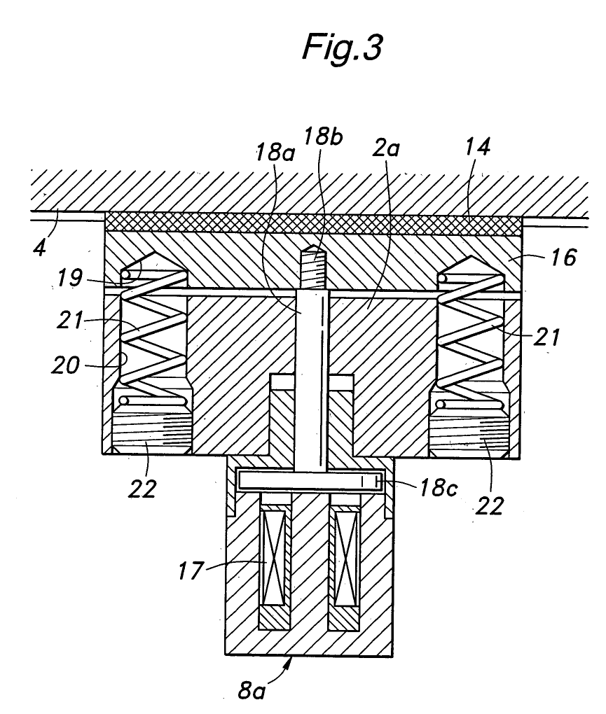

The slider 2a including the moveable slide block 16 is additionally provided with a solenoid device 8a including an electromagnet 17 and an armature 18 which includes a rod-like main part 18a which is passed centrally through and guided by a hole formed in a lid member of the solenoid device and a corresponding hole passed through the slider 2a, a first end threaded or otherwise attached to the movable slide block 16 and a second end 18c in the form of a disk so as to be attracted to the electromagnet 17 when the latter is energized. (The slider 2b is similarly provided with a solenoid device 8b.) As shown in FIG. 3, a pair of through holes 20 are passed through the slider 2a, and each through hole 20 communicates with a recess 19 formed in the moveable slide block 16. A compression coil spring 21 is received in each through hole 20 so that the inner end of the coil spring 21 is received by the corresponding recess 19, and the outer end of each through hole 20 is closed by a threaded bolt 22. By threading each threaded bolt 22 into and out of the through hole 20, the spring force of the compression coil spring 21 can be adjusted. The spring force determines the braking force produced by the brake system.

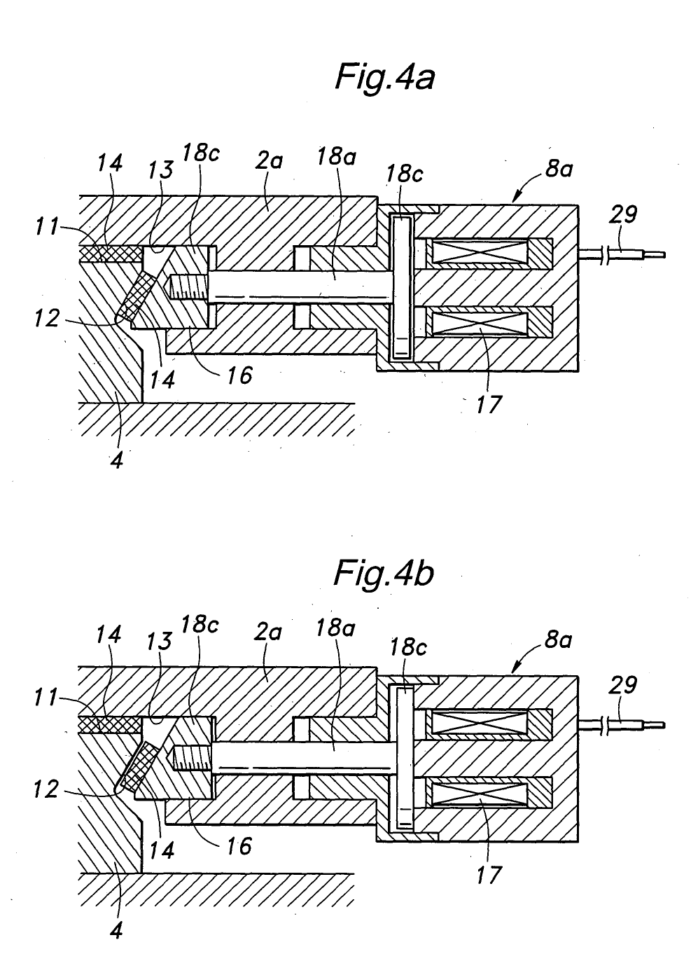

Therefore, when the solenoid device 8a is not energized, the moveable block 16 is urged against the corresponding oblique side surface 12 of the guide rail 4 via the bearing member 14, and the spring force of the coil springs 20 is selected so that a required braking force is produced. When the solenoid device is energized, the armature 18 pulls the moveable slide block 16 away from the oblique side surface 12 of the guide rail 4 against the spring force of the coil springs 21 with the result that the table 3 is allowed to move along the guide rail 4 substantially without any friction. The solenoid device 8a is thus normally energized, and keeps the brake system disengaged, but can quickly engage the brake system in case of a power outage or other abnormal situations. The gap between each bearing member 14 and the opposing side surface 12 (which is shown in FIG. 4b in a somewhat exaggerate manner) is selected in such a manner that the play in the engagement between the guide rail 4 and slider 2a and the friction force are both within tolerable ranges in the disengaged state of the brake system.

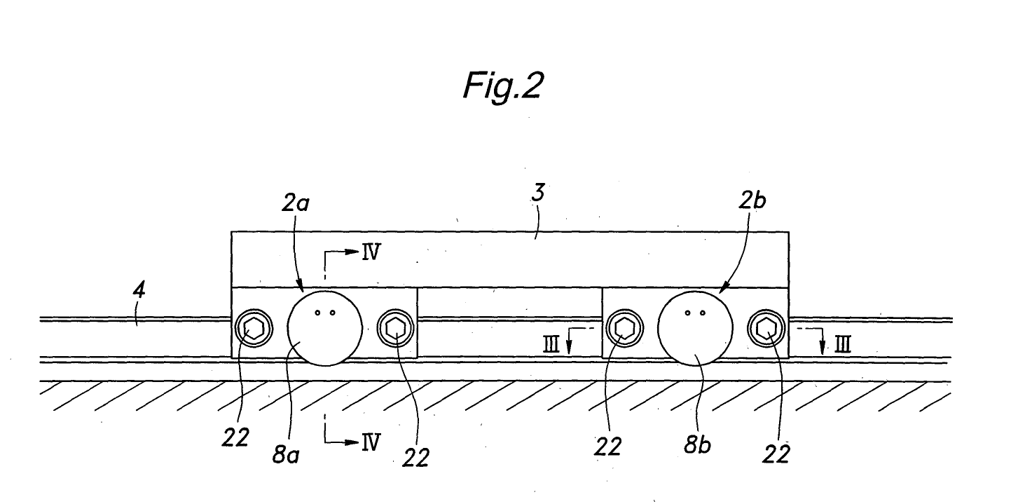

In this embodiment, a pair of brake units are provided on one side of the table 3 as shown in FIG. 2, and the solenoid devices 8a and 8b and coil springs 21 act upon the outer slide blocks 16. When each brake unit is engaged, the corresponding coil springs 21 push the corresponding slide block 16 against the corresponding side surface 12 of the guide rail 4. The pressure on the side surface 12 produces a vertical component of force, and this force is supported by the engagement between the upper surface 11 of the guide rail 4 and bottom surface of the slider 3 via the bearing member 14. At the same time, the pressure applied to the side surface 12 by the moveable slide block 16 pulls the slider 2a toward the solenoid device 8a causing the fixed slide block 15 to bear upon the corresponding side surface 12 of the guide rail 4. As a result, the spring force urges the slide blocks 15 and 16 and slider 2a onto the guide rail 4 from three directions. Also, in the illustrated embodiment, the bearing members 14 serve as members both for providing sliding surfaces guiding the motion of the table 3 and brake surfaces for frictionally braking the table 3.

Although the brake systems are provided only on one side of the table 3, the brake force may be produced on both sides of the table 3 by suitable determining the gaps between the guide rail 4 and sliders 2a and 2c. More specifically, when the solenoid device 8a is deenergized, and the moveable slide block 16 is pushed against the opposing oblique surface 12, the resulting reaction causes the table 3 to be pulled toward the solenoid device 8a. If the various dimensions are selected in such a manner that the outer slide block 26 on the side remote from the solenoid device 8a is pushed against the opposing oblique surface 12 of the guide rail 4 with a greater pressure than the inner slide block 15 on the side of the solenoid device 8a is pushed against the opposing oblique surface 12 of the guide rail 4, the brake force of the brake system is in effect produced by the outer slide blocks 16 and 26 with the result that the brake force is laterally evenly applied to the table 3, and a moment or other complex force would not act upon the sliders or the brake system.

In the illustrated embodiment, the moveable slide block 16 was located on the outer side of the cooresponding slider 2a, but it may also be located on the inner side of the slider 2a. In such a case, an even braking action can be achieved by determining the various gaps and dimensions of the sliders in such a manner that the inner slide block on the side remote from the solenoid device 8a is pushed against the opposing oblique surface 12 of the guide rail 4 with a greater pressure than the outer slide block 15 on the side of the solenoid device 8a is pushed against the opposing oblique surface 12 of the guide rail 4.

In the foregoing embodiment, the bearing members 14 were fixedly attached to the side of the sliders (the bottom surface of the sliders and the oblique sides of the slide blocks), and this arrangement allows relatively small bearing members to be used. However, if desired, some or all of the bearing members may be attached to the guide rail 4 instead. Also, the number of sliders and brake systems may be freely selected as can be readily appreciated by a person skilled in the art. If the table has a large size, it may be desirable to use more than four sliders. Also, the brake units may be provided on either side in a symmetric manner, and/or the number of brake units may be selected freely depending on the need for an even braking action and/or the magnitude of the braking load.

The material for the bearing members 14 may be selected from any of a number of available bearing materials. It is desired to be provided with necessary wear resistance and a load bearing capability, and is desired not to damage the opposing member such as the guide rail which is typically made of stainless steel. The bearing members are desired to have a suitable friction coefficient that would allow them both as sliding members and brake members depending on the pressure by which they are applied to the opposing surfaces. A preferable range of static frictional coefficient of the bearing material is from 0.15 to 0.25.

Preferred materials that would meet such criteria include the porous ceramic material generally known as RB ceramics. RB ceramics is a friction/slide material that does not require lubrication and is typically prepared by mixing rice bran or other wood-base or plant-base material with phenol resin, and sintering the mixture. The inventors have verified that this material is indeed a favorable material for implementing the present invention. However, it does not mean other materials are excluded. On the contrary, there are a number of other materials that could be used in an equally satisfactory manner.

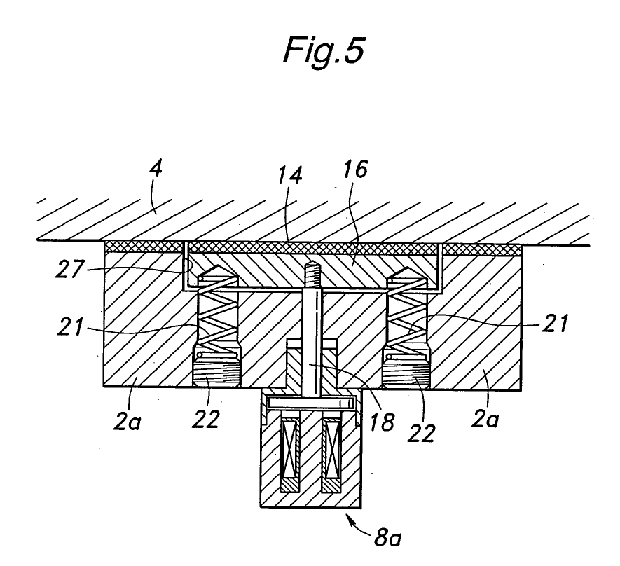

FIG. 5 shows a second embodiment of the present invention, and the parts corresponding to those of the previous embodiment are denoted with like numerals. In the previous embodiment, the moveable slide block had a substantially same length as the corresponding slider, and these two parts were coextensive in the longitudinal direction. In the second embodiment, the slider 2a is provided with a recess 27 for receiving a moveable slide block 16 therein. Therefore, the side surfaces of the recess 27 provides a guide action for the movement of the moveable slide block 16 toward and away from the side surface 12 of the guide rail. Also, the moveable slide block 16 has a substantially smaller length than the slider 2a so that the slide block 16 is pushed against the opposing oblique surface 12 of the guide rail 4 over a relatively small surface area via a bearing member 14, and this provides a better braking action depending on the nature of the bearing member 14.

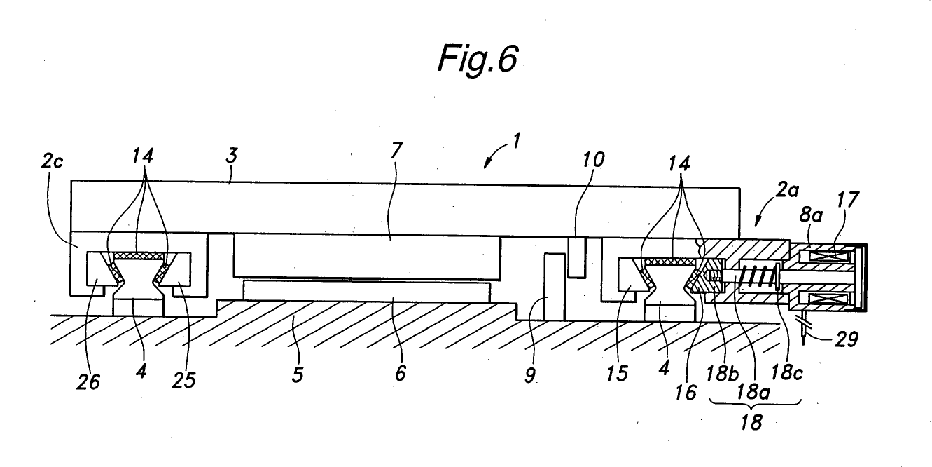

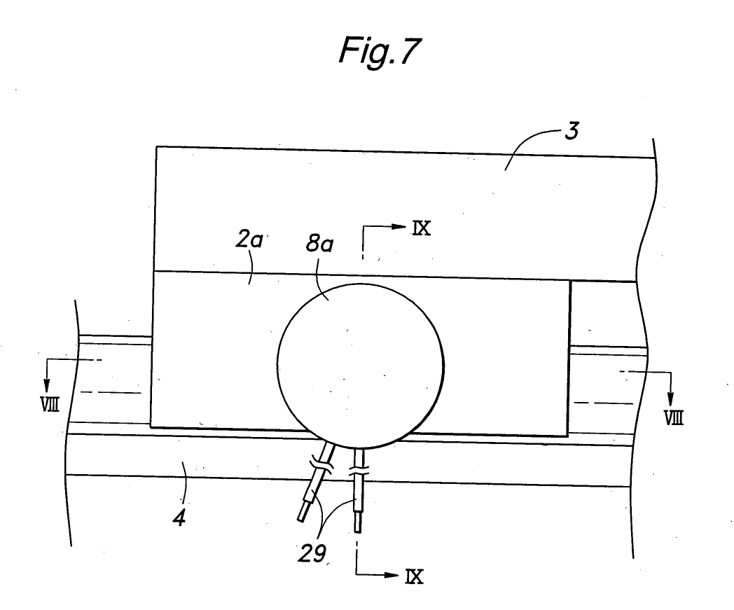

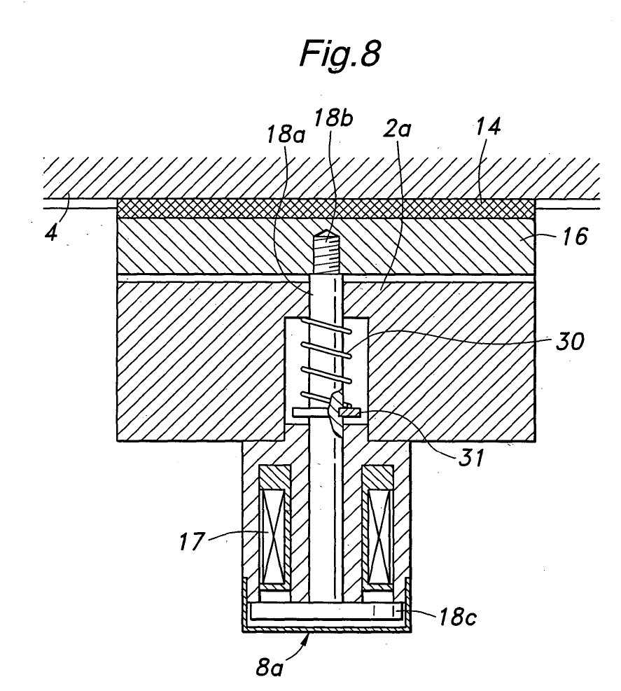

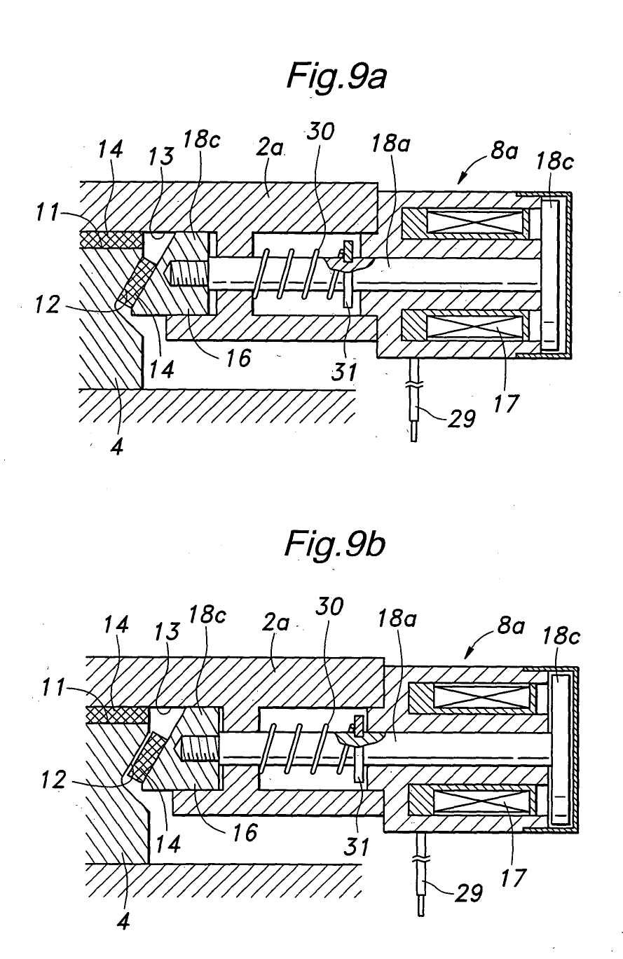

FIGS. 6 to 9 show a third embodiment of the present invention, and the parts corresponding to those of the previous embodiment are denoted with like numerals. In this embodiment, the brake system becomes engaged when power is supplied. The armature 18 of the solenoid device 8a is provided with a rod-like main part 18a, a first end threaded or otherwise attached to the movable slide block 16 and a second end 18c in the form of a disk so as to be attracted to the electromagnet 17 when the latter is energized. In this embodiment, as opposed to the first embodiment, the rod-like main part 18a is passed and guided centrally through the electromagnet 17, and the magnetic gap between the second end 18c of the armature 18 and the electromagnet 17 is formed on the side of the electromagnet 17 remote from the moveable block 16. A compression coil spring 30 is interposed between a retainer ring 31 attached to the rod-like main part 18a and an opposing surface of the movable slide block 16. Therefore, when the electromagnet 17 is energized, the brake system is engaged by the solenoid device 8a against the spring force the coil spring. When the electromagnet 17 is deenergized, the brake system is disengaged under the spring force of the coil spring 30.

The solenoid is typically connected to an emergency power source so as to be energized when such a need arises. Therefore, the solenoid is normally deenergized, and does not consume any power when not in use. When the power is removed from the solenoid, the brake system is disengaged under the spring force of the coil spring 30 without requiring any other means.

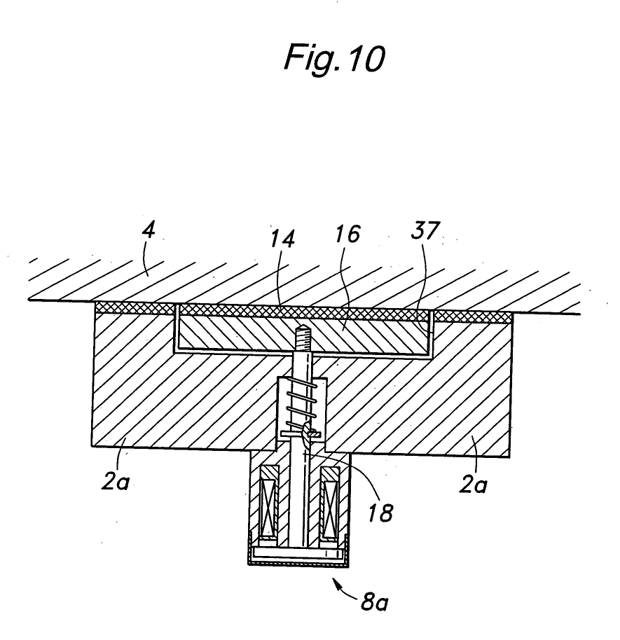

FIG. 10 shows a fourth embodiment of the present invention, and the parts corresponding to those of the previous embodiment are denoted with like numerals. In the previous embodiment, the moveable slide block had a substantially same length as the corresponding slider, and these two parts were coextensive in the longitudinal direction. In the fourth embodiment, the slider 2a is provided with a recess 37 for receiving a moveable slide block 16 therein. Therefore, this embodiment provides similar advantages as those of the second embodiment illustrated in FIG. 5.

Although the present invention has been described in terms of preferred embodiments thereof, it is obvious to a person skilled in the art that various alterations and modifications are possible without departing from the scope of the present invention which is set forth in the appended claims.

1. A brake system for a linear actuator, comprising:
a guide rail;
a table including a slider which is guided by said guide rail for a motion along a length of said guide rail, said slider comprising a moveable slide block that is adapted to slide along a surface of said guide rail and is supported by said slider so as to be moveable toward and away from said guide rail surface;
a linear motor for actuating said table along said guide rail; and
a power actuator for selectively moving said moveable slide block toward said guide rail surface;
said moveable slide block sliding over said guide rail surface for a guiding action in a first state of said power actuator and bearing upon said guide rail surface for a braking action in a second state of said power actuator.

2. A brake system for a linear actuator according to claim 1, wherein said power actuator comprises a solenoid device for moving said slide block toward said guide rail surface when energized and a spring member for moving said slide block away from said guide rail surface when said solenoid device deenergized.

3. A brake system for a linear actuator according to claim 1, wherein said power actuator comprises a solenoid device for moving said slide block away from said guide rail surface when energized and a spring member for moving said slide block toward said guide rail surface when said solenoid device deenergized.

4. A brake system for a linear actuator according to claim 1, wherein said guide rail comprises a pair of mutually parallel guide rail members, and said table comprises a pair of laterally arranged sliders in a corresponding manner.

5. A brake system for a linear actuator according to claim 4, wherein each of said guide rail members is provided with an upper surface and a pair of side surfaces each forming an acute angle with respect to said upper surface, and one of said sliders is provided with a bottom surface engaging said upper surface, a fixed slide block engaging one of said side surfaces while said moveable slide block engaging the other of said side surfaces.

6. A brake system for a linear actuator according to claim 5, wherein the other of said sliders is provided with a bottom surface engaging said upper surface, a pair of fixed slide blocks engaging the corresponding side surfaces of said guide rail.

7. A brake system for a linear actuator according to claim 6, wherein said sliders are dimensioned in such a manner that when said power actuator is in said second state, said moveable slide block of said one slider and one of the fixed slide blocks of said other slider which is located in a symmetric position to said moveable slide block bear upon the corresponding side surfaces of said guide rail.

8. A brake system for a linear actuator according to claim 1, wherein a bearing member is interposed between said slide block and guide rail surface.

9. A brake system for a linear actuator according to claim 8, wherein said bearing member has a static frictional coefficient in the range of 0.15 to 0.25 with respect to the opposing surface.

10. A brake system for a linear actuator according to claim 8, wherein said bearing member comprises a porous carbon material prepared by sintering a mixture of plant-base carbon and phenol resin.
